(19) United States
(12) Patent Application Publication
(10) Pub. No.: US 2003/0079151 A1
(43) Pub. Date: Apr. 24, 2003

(54) Energy-aware workload distribution

(75) Inventors: Patrick Joseph Bohrer, Austin, TX (US); Bishop Chapman Brock, Coupland, TX (US); Elmootazbellah Nabil Elnozahy, Austin, TX (US); Thomas Walter Keller, Austin, TX (US); Michael David Kistler, Pflugerville, TX (US); Ramakrishnan Rajamony, Austin, TX (US)

Correspondence Address: Kelly K. Kordzik, 5400 Renaissance Tower, 1201 Elm Street, Dallas, TX, 75270, US

(73) Assignee: International Business Machines Corporation, Armonk, NY

(21) Appl. No.: 09/981,872

(22) Filed: Oct. 18, 2001

(51) Int. Cl. G06F 1/26; G06F 1/32

(52) U.S. Cl. 713/320

(57) ABSTRACT

The distribution of power dissipation within cluster systems is managed by a combination of inter-node and intra-node policies. The inter-node policy consists of subdividing the nodes within the cluster into three sets, namely the “Operational” set, the “Standby” set and the “Hibernating” set. Nodes in the Operational set continue to function and execute computation in response to user requests. Nodes in the Standby set have their processors in the low-energy standby mode and are ready to resume the computation immediately. Nodes in the Hibernating set are turned off to further conserve energy, and they need a relatively longer time to resume operation than nodes in the Standby set. The inter-node policy further distributes the computation among nodes in the Operational set such that each node in the set consumes the same amount of energy. Moreover, the inter-node policy responds to decreasing workload in the cluster by moving processors from the Operational set into the Standby set and by moving nodes from the Standby set into the Hibernating set. Vice versa, the inter-node policy responds to increasing workload in the cluster by moving nodes from the Hibernating set into the Operational set. Intra-node policies corresponding to managing the energy consumption within each node in the Operational nodes set by scaling operating frequency and power supply voltage corresponding to a given performance requirement.

### TECHNICAL FIELD

The present invention relates in general to managing the distribution of power dissipation within multiple processor cluster systems.

### BACKGROUND INFORMATION

Some computing environments utilize multiple processor cluster systems to manage access to large groups of stored information. A cluster system is one where two or more computer systems work together on shared tasks. The multiple computer systems may be linked together in order to benefit from the increased processing capacity, handle variable workloads, or provide continued operation in the event one system fails. Each computer may itself be a multiprocessor (MP) system. For example, a cluster of four computers, each with four CPUs or processors, may provide a total of 16 CPUs processing simultaneously.

Servers used to manage access to data accessed on the World Wide Web (Web) pages or data accessed over the Internet may employ large cluster MP systems to guarantee that multiple users have quick access to data. For example, if a Web page is used for sales transactions, the owner of the Web page does not want any potential customer to wait an extensive period for their information exchange. A Web page host would retrieve a Web page from storage (e.g., disk storage) and store a copy in a Web cache that is maintained in main memory if a large number of accesses or “hits” were expected or recorded. As the number of hits to the page increases, the activity of the memory module storing the Web page would increase. This activity may cause a processor, memory, or sections of the memory to exceed desired power dissipation limits.

HyperText Transport Protocol (HTTP) is the communications protocol used to connect to servers on the World Wide Web. Its primary function is to establish a connection with a Web server and transmit HTML pages to the client browser. Having a large number of users accessing a particular HTML page may cause the memory unit and processor retrieving and distributing the HTML page to reach a peak power dissipation level. While the processor and memory unit may have the speed to handle the requests, their operating environment may produce high local power distribution.

Web cache appliances are deployed in a network of computer systems that keep copies of the most-recently requested Web pages in various memory units in order to speed up retrieval. If the next Web page requested has already been stored in the cache appliance, it is retrieved locally rather than from the Internet. Web caching appliances (sometimes referred to as caching servers or cache servers) may reside inside a company's firewall and enable all popular pages retrieved by users to be instantly available. Web caches are used to store data objects, and may experience unequal power dissipations within a cluster system if one particular data object is accessed at high rates or a data object's content requires high-power memory activity each time it is accessed.

There is, therefore, a need for a method of managing the distribution of power dissipation within processors or memory units used in a cluster system accessing data objects when the data objects experience high access rates or generate large intrinsic power dissipation when accessed.

### SUMMARY OF THE INVENTION

The distribution of power dissipation within cluster systems is managed by a combination of intra-node and inter-node policies. The intra-node policy consists of adjusting the clock frequency and supply voltage of the processor inside the node to match the workload. The inter-node policy consists of subdividing the nodes within the cluster into three sets, namely the “operational” set, the “standby” set and the “hibernating” set. Nodes in the Operational set continue to function and execute computation in response to user requests. Nodes in the Standby set have their processors in the low-energy, standby mode and are ready to resume the computation immediately. Nodes in the Hibernating set are turned off to further conserve energy, and they need a relatively longer time to resume operation than nodes in the Standby set. The inter-node policy further distributes the computation among nodes in the Operational set such that each node in the set consumes the same amount of energy. Moreover, the inter-node policy responds to decreasing workloads in the cluster by moving processors from the Operational set into the Hibernating set. Vice versa, the inter-node policy responds to increasing workloads in the cluster by moving nodes from the Hibernating set into the Standby set and from the Standby set into the Operational set.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a cluster system suitable for practicing the principles of the present invention.

FIG. 2 is a flow diagram of method steps according to an embodiment of the present invention; and

FIG. 3 is a block diagram of some details of one type of cluster system suitable for practicing the principles of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known concepts have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

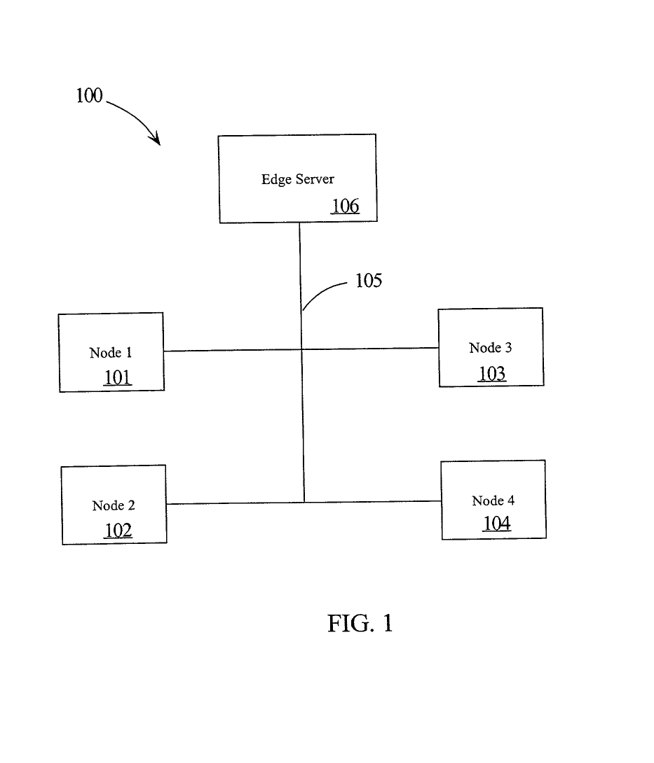

The selected elements of a cluster system 100 according to one embodiment of the invention are depicted in FIG. 1. It is to be understood that selected features of cluster system 100 may be implemented by computing devices that are controlled by computer executable instructions (software). Such software maybe stored in a computer readable medium including volatile mediums such as the system dynamic random access memory (DRAM) or static random access memory (SRAM) as cache memory of server 106 as well as non-volatile mediums such as a magnetic hard disk, floppy diskette, compact disc read-only memory (CD ROM), flash memory card, digital versatile disk (DVD), magnetic tape, and the like.

FIG. 1 is a high-level functional block diagram of a representative cluster system 100 that is suitable for practicing the principles of the present invention. Cluster system 100 includes multiple nodes 101, 102, 103, and 104, connected by a network 105. Each of the nodes 101, 102, 103 and 104 comprises a computing system further comprising a number of processors coupled to one or more memory units (not shown). Each node may contain an I/O bus such as the Peripheral Control Interface (PCI) bus, connecting the processors and memory modules to input-output devices such as magnetic storage devices and network interface cards.

Network 105 connects the processors in the cluster and may follow any standard protocol such as Ethernet, Token Ring, Asynchronous Transfer Mode (ATM), and the like. Cluster system 100 may be connected to the rest of the Internet through an edge server 106, which acts as a gateway and a workload distributor. Each of the nodes 101, 102,103 and 104 includes a mechanism and circuitry to control the frequency and supply voltage of the processors within the node. Within each node, the circuitry controlling the frequency and supply voltage for each processor adjusts the voltage supply of the processors in response to the workload on the node. If the node workload increases, the voltage is increased commensurately, which in turn enables increasing the operating frequencies of the processors to improve the overall system performance. In multiprocessing systems, a node may be a single processor or system. In a massively parallel processing system (MPP), it is typically one processor and in a symmetrical multiprocessor system (SMP) it is a computer system with two or more processors and shared memory. In this disclosure, a node is used to indicate a processing unit which may comprise single or multiple processors in either an MPP or an SMP configuration. The action taken by the Edge server 106 corresponding to a node (e.g., one node of nodes 101-104) will be compatible with the architecture of the particular node.

Edge server 106 contains a gateway that connects the cluster to the Internet. It may include software to route packets according to the Transmission Control Protocol (TCP) of the Internet Protocol suite (IP). In embodiments of the present invention, Edge server 106 also receives feedback from each of the nodes about the level of utilization of the processor(s) within each node.

When the nodes within the cluster execute computations, they consume energy proportional to their computation workloads. It has been established in the art that the energy consumed by a processor is proportional to its operating frequency and to the power supply voltage of its logic and memory circuits. If the frequency of a processor should be increased to support a workload, its power supply voltage may also have to be increased to support the increased frequency. Since the energy consumption of a processor is non-linearly related to its supply voltage, it may be advantageous to distribute a workload to another processor rather than increase frequency to support the workload in one processor. Therefore, it is advantageous to reduce workloads such that processors may operate at lower frequencies and supply voltages and thus consume substantially less energy than they would otherwise consume while operating at the peak frequency and voltage. In a cluster system environment, the workload is not necessarily distributed evenly among all the processors. Therefore, some processors may require operation at a very high frequency while others may be idle. This unbalance may not yield optimal power distribution and energy consumption for a given workload.

According to embodiments of the present invention, a Workload Distribution Policy (WDP) is implemented in Edge server 106. The WPD functions to reduce the energy consumption and power distribution across the cluster. According to one embodiment of the present invention, the WPD has five elements. One element of the WPD comprises designating three types of node sets across the cluster system 100. In the first node set, designated the Operational set, all nodes execute computations in response to user requests. Each node in the Operational set employs voltage and frequency scaling to manage the energy consumed within the node corresponding to its workload. The second node set is designated the Standby node set, comprises nodes that have been put in standby mode by the power management mechanism within each node. The memory system corresponding to the processor(s) in the Standby node set is maintained in a power-up state when a processor is put in a standby mode. As a result the memory and peripherals continue to consume energy, but the standby processors have negligible energy consumption. A processor in the Standby node set may be brought on-line to resume operation within a very short time. The third node set, designated the Hibernating node set, comprises all of the nodes which have been powered down and are in a “hibernate” mode. While a processor in a Hibernating node set does not consume any energy, it may not resume operation immediately and may typically go through a relatively lengthy startup process.

A second element of the WPD for system 100 comprises designating a desirable workload range in which it is desirable to operate nodes in the Operational node set. The workload range is set to correspond to a predetermined upper workload bound (WL1) and a lower workload bound (WL2). WL1 is chosen according to sound engineering principles in regard to system performance and energy consumption within a node in the Operation node set. Setting WL1 too high may drive a node into performance instability and may force the node to consume high energy. On the other hand, setting WL2 too low may create a situation where a node is under utilized. In embodiments of the present invention, Edge server 106 periodically receives feedback data from each node concerning current workload and energy consumption and uses this feedback data to adjust the workload distribution within the cluster system 100.

A third element of the WPD comprises balancing the energy consumption among the nodes within the Operational node set. Edge server 106 monitors the utilization in each node and if it detects that the workload of one node has increased to above average, it distributes the workload across other nodes so that nodes in the Operational node set have balanced energy consumption. Likewise, if the workload of one node decreases to less than average, edge server 106 may reassign the workload of other nodes to the under utilized node to insure that the energy consumption is balanced across the nodes in the Operational node set.

A fourth element of WPD comprises reassigning nodes within the three node sets in the cluster system 100 in response to increasing workloads. If edge server 106 detects that the average workload among the nodes in the Operational set exceeds WL1, it reassigns one node from the Standby node set into the Operational node set, and reassigns one node from the Hibernating node set into the Standby node set. This requires Edge server 106 to send the appropriate signals to the nodes using a protocol such as Wake-On-LAN. Edge server 106 then redistributes the workload among the nodes in the Operational node set so that the average workload of each node is brought down below WL1. The redistribution may use any reasonable workload distribution policy as established in the art, subject to remaining within the constraints of WL1 and WL2. Edge server 106 may iterate the process as many times as needed until the workload is brought to a value below WL1 or until either the Hibernate or Standby node set is exhausted (all nodes in the node sets have been utilized). Note that it is important to avoid a situation where the redistribution causes oscillation. Those well versed in the art would appreciate that there are methods to avoid oscillation if it occurs.

A fifth element of the WPD comprises reassigning nodes within the three node sets in response to decreasing workloads. If edge server 106 detects that the average workload among the nodes in the Operational node set has dropped below WL2, it reassigns one node from the Operational node set into the Hibernate node set. In this fifth element of the WPD, Edge server 106 may redistribute the workload of the selected node to the rest of the nodes in the Operational node set by sending the appropriate signals to the selected node. The selected node typically includes software and circuitry to enable the node to be powered down in a controlled fashion. Edge server 106 may iterate the process in the fifth element of the WPD as many times as necessary until either the average workload is brought above WL2 or the Operational set contains only one node.

One skilled in the art will realize that the functionality assigned to Edge server 106 may be performed by other devices or one of the Operational nodes and that the connection among the described nodes may be accomplished by a tightly coupled bus instead of a network. Such modifications are not in conflict with the fundamentals of the invention and may be incorporated in a straightforward manner by those versed in the art.

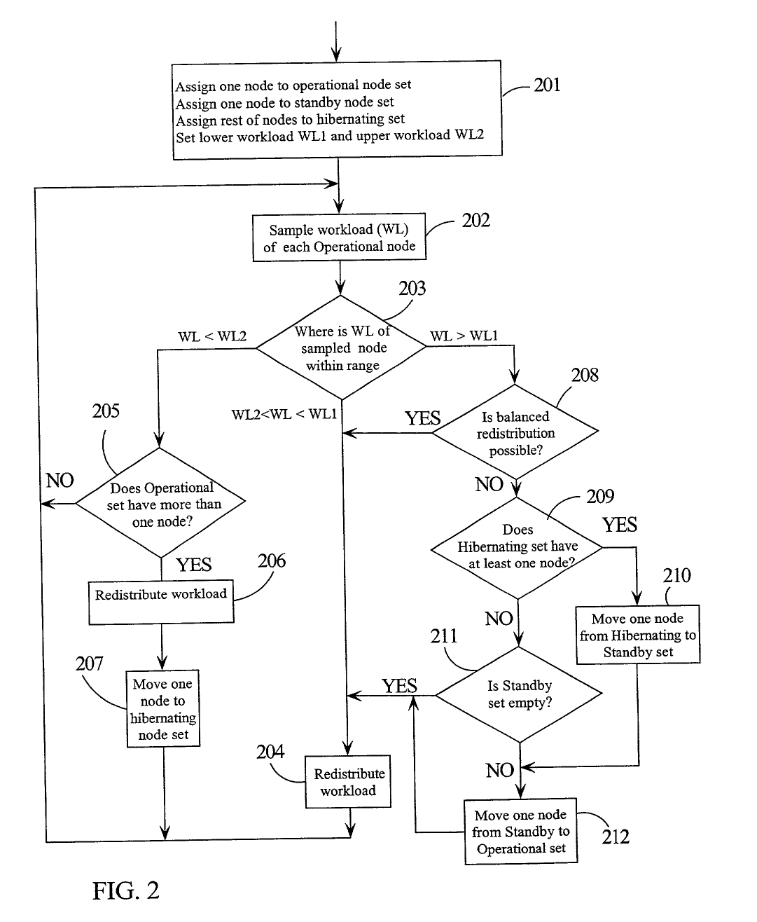

FIG. 2 is a flow diagram of method steps according to an embodiment of the present invention. In step 201, at least one node is assigned to the Operational node set, at least one node is assigned to the Standby node set, and the remaining nodes are assigned to the Hibernating set. All nodes in the Standby node set are put in standby mode while all nodes in the Hibernating node set are put in a Hibernate mode. All nodes in the Operational node set are set to function normally while optionally performing voltage and frequency scaling at the node level to adapt to the workload. In step 201, workload thresholds WL1 and WL2 are also initialized.

In step 202, the average workloads (WL) of all Operational nodes are sampled. In step 203, a determination is made of the WL position in the range between WL1 and WL2. If WL2<WL<WL1, then in step 204 the workload across the cluster is balanced so that the actual workload in each node is as close to WL as is possible. If in step 203 it is determined that a node's WL is less than WL2, then the number of nodes in the Operational node set is tested in step 205. If the number of nodes in the Operational node set is greater than one in step 205, then in step 206 the workload is redistributed in preparation for moving the node with WL<WL2 to the Hibernating node set. In step 207, the node is then moved into the Hibernating node set where it is powered off to conserve energy. A branch is then taken to step 202 where the workloads of the Operational node set are monitored by sampling. If in step 205 there is not more than one Operational node, then no action may be taken and a branch is taken back to step 202 where the workloads of the Operational node set are monitored by sampling. If in step 203 it is determined that the sampled WL is greater than WL1, then a test is done in step 208 to determine if WL maybe reduced below WL1 by redistributing workloads. If the result of the test in step 208 is YES, then a branch is taken to step 204 where the workload is redistributed with an attempt to get all workloads between WL1 and WL2. If the result of the test in step 208 is NO, then in step 209 the number of nodes in the Hibernating set is examined. If the number of nodes in step 209 is at least one, then one node from the Hibernating set is put it in the Standby mode in step 210 thereby moving it into the Standby set. Next in step 212, one node from the Standby set is moved into the Operational set. Note that steps 210 and 212 may occur in parallel to expedite the workload transfer. If the result of the test in step 209 is NO, then a test is done in step 211 to determine if the Standby set is empty. If the result of the test in step 211 is NO, then in step 212 anode is moved from the Standby set to the Operational set and step 204 is executed as described above. If the result of the test in step 211 is YES, then there are no nodes to activate from the Standby set and step 204 is executed to attempt the best workload balance within the available Operation node sets.

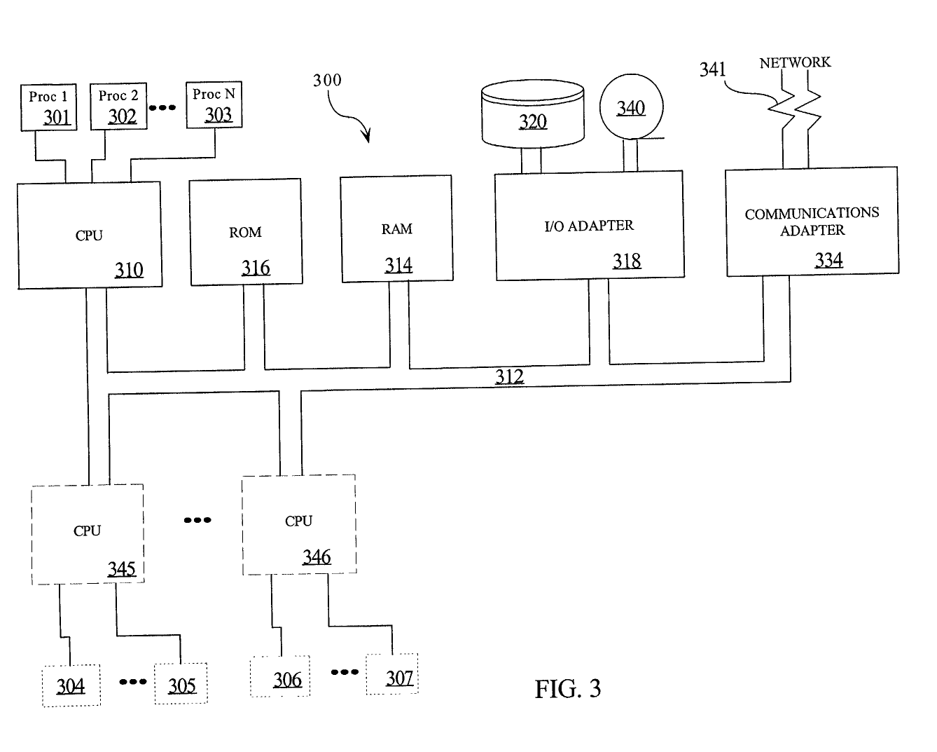

FIG. 3 is a high level functional block diagram of a representative data processing system 300 suitable for practicing the principles of the present invention. Data processing system 300, may include multiple central processing systems (CPUs) 310 and 345. Exemplary CPU 310 includes multiple processors (MP) 301-303 in an arrangement operating as a cluster system in conjunction with a system bus 312. The processors 301-303 in CPU 310 maybe assigned to work on tasks in groups within various program executions which entail persistent connections and states according to embodiments of the present invention. System bus 312 operates in accordance with a standard bus protocol such that as the ISA protocol compatible with CPU 310. CPU 310 operates in conjunction with a random access memory (RAM) 314. RAM 314 includes DRAM (Dynamic Random Access Memory) system memory and SRAM (Static Random Access Memory) external cache. System 300 may also have additional CPU 345 with corresponding processors 304-305. I/O Adapter 318 allows for an interconnection between the devices on system bus 312 and external peripherals, such as mass storage devices (e.g., an IDE hard drive, floppy drive or CD/ROM drive). A peripheral device 320 is, for example, coupled to a peripheral control interface (PCI) bus and I/O adapter 318 therefore may be a PCI bus bridge. Data processing system 300 may be selectively coupled to a computer or telecommunications network 341 through communications adapter 334. Communications adapter 334 may include, for example, a modem for connection to a telecom network and/or hardware and software for connecting to a computer network such as a local area network (LAN) or a wide area network (WAN). Code within system 300 may be used to manage energy consumption of its processors (e.g., 301-307) which includes methods of scaling frequency and voltage. Optimization routines maybe run to determine the combination of an operating frequency and voltage necessary to maintain a required performance. Embodiments of the present invention may be triggered by a request to modify the system 300 workload or by processes within system 300 completing. System 300 may also run an application program that executes system energy consumption management according to embodiments of the present invention. The application program may be resident in any one of the processors 301-307 or in processors (not shown) connected via the communications adapter 334. System 300 may also operate as one of the nodes (101-104) described relative to FIG. 1. Other system configurations employing single and multiple processors and using elements of system 300 may also be used as computation nodes according to embodiments of the present invention.

In embodiments of the present invention, the Operational nodes execute an intra-node optimization technique to determine if the performance requirements of the nodes maybe met by reducing the operating frequency and/or the operating power supply voltage of processors within the Operational nodes. If the performance requirements can be met under reduced frequency and voltage conditions, then the frequency and voltage are systematically altered to optimize energy consumption.

Although the present invention and its advantages have been described in detail, it should be understood that various changes, substitutions and alterations can be made herein without departing from the spirit and scope of the invention as defined by the appended claims.

What is claimed is:

1. A method of energy management in a computer system having a plurality of computation nodes comprising the steps of:
assigning a first computation node to an Operational node set as an Operational node, wherein said first computation node is a fully active node;
assigning a second computation node to a Standby node set as a Standby node, wherein said second computation node has its processor(s) and memory in a minimum power consumption state corresponding to maintaining essential data; and
assigning remaining of said plurality of computation nodes excluding said first and second nodes to a Hibernating node set as hibernating nodes, wherein hibernating nodes are maintained in a powered down state.

2. The method of claim 1 further comprising the steps of:
setting a lower computational workload limit (WL2) and a upper computational workload limit (WL1) for said first computation node; and
comparing an actual average workload (WL) of said first computation node to said WL2 and said WL1.

3. The method of claim 2 further comprising the steps of:
redistributing the workload of said first computation node to a third computation node in said Operational node set when said WL of said first computation node is less than WL2; and
moving said first computation node to said Hibernating node set.

4. The method of claim 2 further comprising the step of:
moving workload from said first computation node to a third computation node when said WL of said first computation node is greater than WL1 such that said WL of said first computation node and a WL of said third computation node both are less than WL1.

5. The method of claim 2 further comprising the steps of:
moving a fifth computation node from said Hibernating node set to said Standby node set in response to a determination that said WL of said first node is greater than WL1;
moving a sixth computation node from said Standby node set to said Operational node set response to said determination that said WL of said first node is greater than WL1; and
redistributing workload from said first computation node to said sixth computation node such that said WL of said first computation node and a WL of said sixth computation node are both less than WL1.

6. The method of claim 1, wherein said computer system is a massively parallel processors system (MPP).

7. The method of claim 6, wherein said computation node comprises a single processor.

8. The method of claim 1, wherein said computer system is a symmetrical multiprocessor system (SMP).

9. The method of claim 8, wherein said computation node comprises multiple processors coupled to a shared memory unit.

10. The method of claim 1, wherein said first computation node executes a process to minimize energy consumption by a combination of voltage and frequency scaling, wherein said minimized energy consumption enables a required performance of said first computation node.

11. A computer program product for, said computer program product embodied in a machine readable medium for energy management in a computer system having a plurality of computation nodes, including programming for a processor, said computer program comprising a program of instructions for performing the program steps of:
assigning a first computation node to an Operational node set as an Operational node, wherein said first computation node is a fully active node;
assigning a second computation node to a Standby node set as a Standby node, wherein said second computation node has its processor(s) and memory in a minimum power consumption state corresponding to maintaining essential data; and
assigning remaining of said plurality of computation nodes excluding said first and second nodes to a Hibernating node set as hibernating nodes, wherein hibernating nodes are maintained in a powered down state.

12. The computer program product of claim 11 further comprising the program steps of:
setting a lower computational workload limit (WL2) and a upper computational workload limit (WL1) for said first computation node; and
comparing an actual average workload (WL) of said first computation node to said WL2 and said WL1.

13. The computer program product of claim 12 further comprising the program steps of:
redistributing the workload of said first computation node to a third computation node in said Operational node set when said WL of said first computation node is less than WL2; and
moving said first computation node to said Hibernating node set.

14. The computer program product of claim 12 further comprising the program step of:
moving workload from said first computation node to a third computation node when said WL of said first computation node is greater than WL1 such that said WL of said first computation node and a WL of said third computation node both are less than WL1.

15. The computer program product of claim 12 further comprising the program steps of:
moving a fifth computation node from said Hibernating node set to said Standby node set in response to a determination that said WL of said first node is greater than WL1;
moving a sixth computation node from said Standby node set to said Operational node set response to said determination that said WL of said first node is greater than WL1; and
redistributing workload from said first computation node to said sixth computation node such that said WL of said first computation node and a WL of said sixth computation node are both less than WL1.

16. The computer program product of claim 11, wherein said computer system is a massively parallel processors system (MPP).

17. The computer program product of claim 16, wherein said computation node comprises a single processor.

18. The computer program product of claim 11, wherein said computer system is a symmetrical multiprocessor system (SMP).

19. The computer program product of claim 18, wherein said computation node comprises multiple processors coupled to a shared memory unit.

20. The computer program product of claim 11, wherein said first computation node executes a process to minimize energy consumption by a combination of voltage and frequency scaling, wherein said minimized energy consumption enables a required performance of said first computation node.

21. A system for energy management in a computer system having a plurality of computation nodes comprising:
circuitry for assigning a first computation node to an Operational node set as an Operational node, wherein said first computation node is a fully active node;
circuitry for assigning a second computation node to a Standby node set as a Standby node, wherein said second computation node has its processor(s) and memory in a minimum power consumption state corresponding to maintaining essential data; and
circuitry for assigning remaining of said plurality of computation nodes excluding said first and second nodes to a Hibernating node set as hibernating nodes, wherein hibernating nodes are maintained in a powered down state.

22. The system of claim 21 further comprising:
circuitry for setting a lower computational workload limit (WL2) and a upper computational workload limit (WL1) for said first computation node; and
circuitry for comparing an actual average workload (WL) of said first computation node to said WL2 and said WL1.

23. The system of claim 22 further comprising:
circuitry for redistributing the workload of said first computation node to a third computation node in said Operational node set when said WL of said first computation node is less than WL2; and
circuitry for moving said first computation node to said Hibernating node set.

24. The system of claim 22 further comprising:
circuitry for moving workload from said first computation node to a third computation node when said WL of said first computation node is greater than WL1 such that said WL of said first computation node and a WL of said third computation node both are less than WL1.

25. The system of claim 22 further comprising:
circuitry for moving a fifth computation node from said Hibernating node set to said Standby node set in response to a determination that said WL of said first node is greater than WL1;
circuitry for moving a sixth computation node from said Standby node set to said Operational node set response to said determination that said WL of said first node is greater than WL1; and
circuitry for redistributing workload from said first computation node to said sixth computation node such that said WL of said first computation node and a WL of said sixth computation node are both less than WL1.

26. The system of claim 21, wherein said computer system is a massively parallel processors system (MPP).

27. The system of claim 26, wherein said computation node comprises a single processor.

28. The system of claim 21, wherein said computer system is a symmetrical multiprocessor system (SMP).

29. The system of claim 28, wherein said computation node comprises multiple processors coupled to a shared memory unit.

30. The system of claim 21, wherein said first computation node executes a process to minimize energy consumption by a combination of voltage and frequency scaling, wherein said minimized energy consumption enables a required performance of said first computation node.
